(19) United States
(12) Patent Application Publication
(10) Pub. No.: US 2024/0116402 A1
(43) Pub. Date: Apr. 11, 2024

(54) ACTIVE SEATING SYSTEM CONTROL BY AN AUTONOMOUS VEHICLE

(71) Applicant: GM Cruise Holdings LLC, San Francisco, CA (US)

(72) Inventors: Rajat Basu, Santa Clara, CA (US); Shahram Rezaei, Danville, CA (US)

(21) Appl. No.: 17/961,418

(22) Filed: Oct. 6, 2022

(51) Int. Cl. B60N 2/02; B60W 40/08; B60W 50/00

(52) U.S. Cl. CPC B60N 2/0244; B60W 40/08; B60W 50/0097; B60W 50/0098; B60N 2002/0268; B60W 2050/0083; B60W 2540/221

(57) ABSTRACT

Systems and techniques are provided for controlling an active seating system in an autonomous vehicle (AV). An example method can include determining an anticipated movement of an autonomous vehicle (AV) based on at least one of AV route data, AV map data, and AV sensor data; determining, based on the anticipated movement, one or more seat operations for an active seating system associated with at least one AV seat, wherein the one or more seat operations are configured to mitigate an effect of the anticipated movement on the at least one AV seat; and sending at least one instruction that includes the one or more seat operations to the active seating system.

### BACKGROUND

### 1. Technical Field

The present disclosure generally relates to autonomous vehicles and, more specifically, to controlling an active seating system by an autonomous vehicle.

### 2. Introduction

An autonomous vehicle is a motorized vehicle that can navigate without a human driver. An exemplary autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Typically, the sensors are mounted at fixed locations on the autonomous vehicles.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 is a diagram illustrating an example system environment that can be used to facilitate autonomous vehicle (AV) navigation and routing operations, in accordance with some examples of the present disclosure;

FIG. 2 is a diagram illustrating an example system for implementing an active seating system in an autonomous vehicle, in accordance with some examples of the present disclosure;

FIG. 3 is a diagram illustrating an example of an active seating system, in accordance with some examples of the present disclosure;

FIG. 4 is a diagram illustrating an example of active seating system measurements, in accordance with some examples of the present disclosure;

FIG. 5 is a flowchart illustrating an example process for controlling an active seating system in an autonomous vehicle, in accordance with some examples of the present disclosure; and

FIG. 6 is a diagram illustrating an example system architecture for implementing certain aspects described herein.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Autonomous vehicles (AVs), also known as self-driving cars, driverless vehicles, and robotic vehicles, are vehicles that use sensors to sense the environment and move without human input. For example, AVs can include sensors such as a camera sensor, a LIDAR sensor, and/or a RADAR sensor, amongst others, which the AVs can use to collect data and measurements that are used for various AV operations. The sensors can provide the data and measurements to an internal computing system of the autonomous vehicle, which can use the data and measurements to control mechanical systems of the autonomous vehicle, such as a vehicle propulsion system, a braking system, and/or a steering system, etc.

In some cases, an autonomous vehicle may be equipped with conventional car seats that remain in a fixed position while the vehicle is in motion. These conventional car seats generally rely on the vehicle suspension system to dampen movement or vibration that may be caused by factors such as road conditions, braking, acceleration, etc. However, a passenger seated in a conventional car seat may experience movement that results in an unpleasant ride experience. For example, the passenger may be shifted left or right when the vehicle turns, or the passenger's head may shift forward during vehicle braking. In addition to hindering the ride experience, these undesired movements may cause or contribute to motion sickness. Further, the issue of motion sickness may be exacerbated in an autonomous vehicle because the passengers may be less attentive to the direction that the vehicle is travelling.

In some instances, a vehicle may be equipped with an active seating system. An active seating system may include one or more actuators that can cause the passenger seat to move in different directions in order to counteract the movement of the vehicle. For example, an active seating system may include an actuator that can cause the seat to move in an upward direction to counteract a downward movement of the vehicle (e.g., vehicle suspension compresses).

Systems and techniques are provided herein for controlling active seating systems in an autonomous vehicle. In some aspects, an autonomous vehicle may use various algorithms and/or vehicle sensors to anticipate and/or detect movement of the autonomous vehicle that may cause passenger movement or discomfort. In some cases, the autonomous vehicle can proactively determine settings for the active seating system that can be used to counteract the anticipated movement. For example, the autonomous vehicle may use a perception algorithm to detect a vehicle that is unexpectedly braking in front of the autonomous vehicle and may configure the active seating system to shift in a backwards direction to counter the effects of the braking.

In some examples, the autonomous vehicle can use sensors such as inertial measurement units (IMU) to further control the active seating system. For example, the IMU can provide real-time data regarding the movement of the autonomous vehicle (e.g., compression of suspension, uneven road, shift due to crosswind, etc.) that can be used to adjust the active seating system.

In some cases, the active seating system can be configured based on the physical attributes of the passenger. For example, the autonomous vehicle can adjust the settings of the active seating system based on passenger height, passenger weight, and/or passenger shape. In some cases, the seat may be configured with additional sensors (e.g., IMUs) that can be used to measure the comfort level of the passenger. In some aspects, the data from the sensors within the seat can also be used to adjust the configuration of the active seating system.

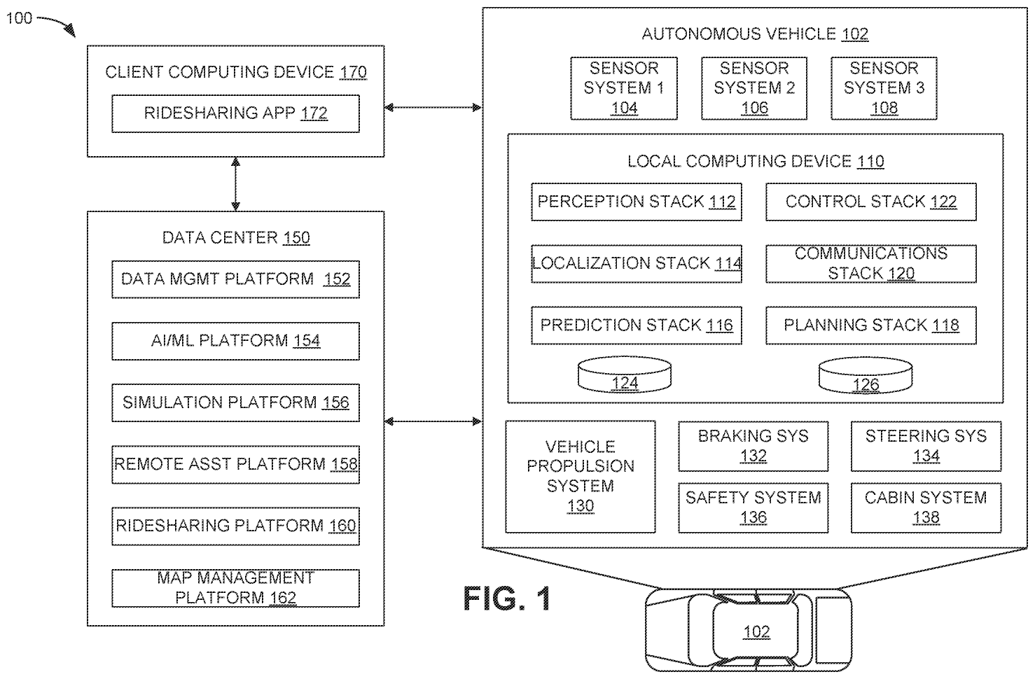

FIG. 1 is a diagram illustrating an example autonomous vehicle (AV) environment 100, according to some examples of the present disclosure. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include one or more types of sensors and can be arranged about the AV 102. For instance, the sensor systems 104-108 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other examples may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can identify environmental uncertainties, such as where to look for moving objects, flag areas that may be obscured or blocked from view, and so forth. In some examples, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some cases, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some examples, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some examples, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridesharing platform 160, and a map management platform 162, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridesharing platform 160, the map management platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from a cartography platform (e.g., map management platform 162); modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ridesharing application 172. The client computing device 170 can be a customer's mobile computing device or a computing device integrated with the AV 102 (e.g., the local computing device 110). The ridesharing platform 160 can receive requests to pick up or drop off from the ridesharing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some aspects, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ridesharing platform 160 may incorporate the map viewing services into the client application 172 to enable passengers to view the AV 102 in transit en route to a pick-up or drop-off location, and so on.

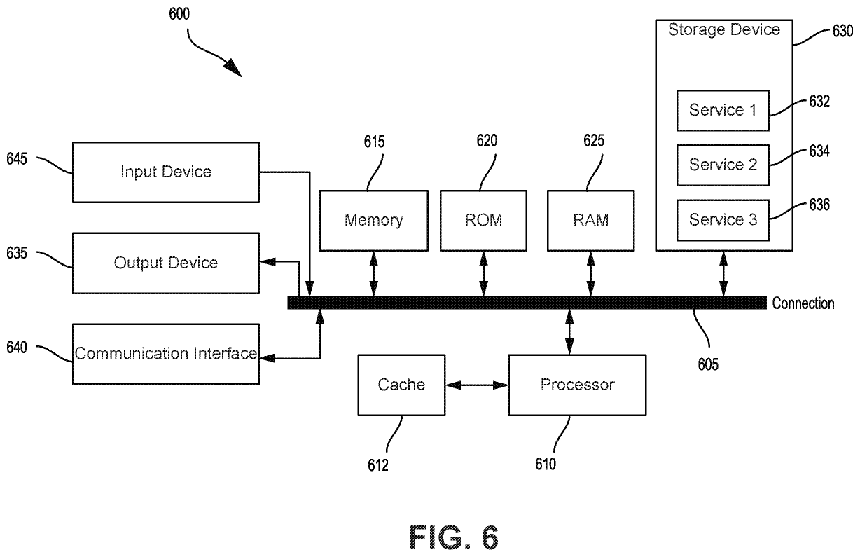

While the autonomous vehicle 102, the local computing device 110, and the autonomous vehicle environment 100 are shown to include certain systems and components, one of ordinary skill will appreciate that the autonomous vehicle 102, the local computing device 110, and/or the autonomous vehicle environment 100 can include more or fewer systems and/or components than those shown in FIG. 1. For example, the autonomous vehicle 102 can include other services than those shown in FIG. 1 and the local computing device 110 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 6.

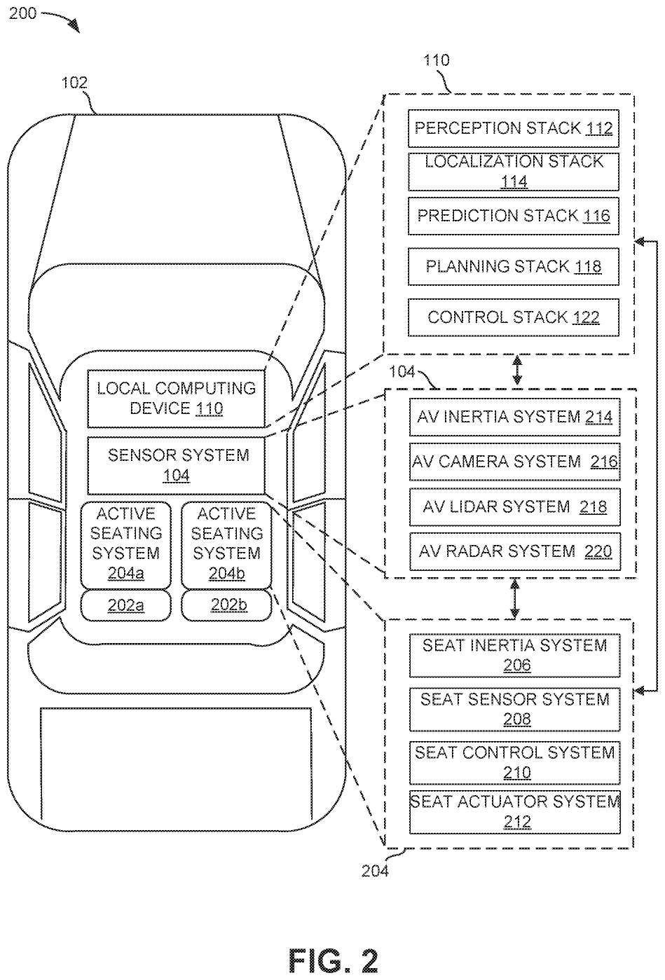

FIG. 2 illustrates an example system 200 for implementing an active seating system in an autonomous vehicle (AV). In some aspects, system 200 can include AV 102 (e.g., as illustrated in FIG. 1). In some cases, AV 102 can include local computing device 110. In some instances, local computing device 110 can include perception stack 112, localization stack 114, prediction stack 116, planning stack 118, and control stack 122. In some examples, AV 102 can include sensor system 104 (e.g., sensor systems 104-108 as illustrated in FIG. 1). For example, sensor system 104 can include AV inertia system 214, AV camera system 216, AV LIDAR system 218, and AV radar system 220.

In some examples, AV 102 may include one or more AV seats such as AV seat 202a and AV seat 202b (collectively referred to as “AV seats 202”). In some cases, one or more of the AV seats 202 may correspond to an active suspension seat that may be controlled by an active seating system. For example, AV seat 202a may be coupled to active seating system 204a and AV seat 202b may be coupled to active seating system 204b (active seating system 204a and active seating system 204b are collectively referred to as “active seating systems 204”). In some aspects, AV seats 202 may include seatbelts that are incorporated as part of AV seats 202 (e.g., not attached to body structure of AV 102). In some examples, the seatbelts may be attached to the body structure of AV 102. In some cases, the configuration of the seatbelt may be used to adjust control of active seating systems 204.

In some cases, active seating systems 204 may include seat inertia system 206, seat sensor system 208, seat control system 210, and/or seat actuator system. In some instances, seat inertia system 206 may include one or more inertia sensors (e.g., inertial measurement units (IMUs), gyroscopes, accelerometers, magnetometers, etc.). In some examples, seat sensor system 208 may include one or more sensors such as pressure sensors and/or weight sensors.

In some cases, seat control systems 210 may include a controller or processor that can provide a communication interface between AV 102 and active seating systems 204. In some aspects, seat control system 210 may be coupled to seat inertia system 206, seat sensor system 208, and/or seat actuator system 212. In some examples, seat control system 210 may be configured to control seat actuator system 212 to cause movement of AV seats 202. In some instances, seat actuator system 212 may include electrical components, mechanical components, and/or electromechanical components that may be used to effectuate movement of AV seats 202. For example, seat actuator system 212 may include rods, axles, pistons, cylinders, valves, rollers, springs, fasteners, wiring, electric actuators, hydraulic actuators, pneumatic actuators, linear motors, rotary motors, any other component, and/or any combination thereof.

In some aspects, seat control systems 210 can be configured to move AV seats 202 in one or more directions. For example, seat control systems 210 can be configured to move AV seats 202 in a vertical direction, a lateral direction, a fore-and-aft direction (e.g., forward and backward), a roll direction, a pitch direction, and/or a yaw direction.

In some examples, local computing device 110 of AV 102 can anticipate movement of AV 102. In some cases, local computing device 110 can communicate with active seating systems 204 to cause movement of AV seats 202 that can compensate or counteract the effects of the anticipated movement. In some aspects, local computing device 110 can anticipate movements of AV 102 that include braking, turns (e.g., right turns, left turns, U-turns), curves, acceleration, deceleration, vehicle inclination (e.g., driving uphill), vehicle disinclination (e.g., driving downhill), uneven rides (e.g., due to road conditions, weather, etc.), etc.

In some cases, local computing device 110 can identify anticipated movements of AV 102 based on data obtained from localization stack 114. For example, local computing device 110 can use vehicle location data from localization stack 114 to identify a position on map (e.g., based on HD geospatial database 126). Based on the position on the map, local computing device 110 can identify road topography (e.g., inclines, declines, bumps, etc.) that may cause movement of AV 102.

In some examples, local computing device 110 can identify anticipated movements of AV 102 based on data obtained from planning stack 118. For example, local computing device 110 can use routing data (e.g., route planning) from planning stack 118 to identify actions that AV 102 will take throughout the route (e.g., turns, braking, acceleration, deceleration, etc.).

In some instances, local computing device 110 can identify anticipated movements of AV 102 based on data obtained from perception stack 112. For example, perception stack 112 can use sensor data obtained from AV camera system 216, AV LIDAR system 218, and/or AV radar system 220 to identify objects (e.g., pedestrians, pets, cyclists, vehicles, road debris, etc.) in the vicinity of AV 102. In some aspects, local computing device 110 can predict or anticipate a movement of AV 102 based on perception of such objects. For instance, perception stack 112 may identify a dog that has run into the street in the path of AV 102 that will result in AV 102 performing a braking operation (e.g., anticipated movement).

In some aspects, local computing device 110 can send instructions to active seating systems 204 to compensate for the expected or anticipated movement. For example, local computing device 110 can send a command to active seating systems 204 that causes AV seats 202 to move backwards to offset the movement of a braking operation by AV 102. In another example, local computing device 110 can send a command to active seating systems 204 that causes AV seats 202 to rotate to the right to offset the movement of a leftward curve. In another example, local computing device 110 can send a command to active seating system 204 that causes AV seats 202 to move upward to offset a dip in the road that causes the suspension of AV 102 to compress.

In some aspects, as an alternative or in addition to configuring active seating systems 204 based on anticipated movements, local computing device 110 can dynamically configure active seating systems 204 based on current sensor data. For example, local computing device 110 may receive data from AV inertia system 214 that indicates a present movement of AV 102. In some cases, local computing device 110 can use the data from AV inertia system 214 to configure and/or modify the configuration of active seating systems 204. For example, local computing device 110 can use data from AV inertia system 214 to modify a configuration of active seating systems 204 that was based on an anticipated movement. In one illustrative example, the data from AV inertia system 214 may indicate that a braking operation is causing a greater amount of movement than was projected based on the anticipated movement and that further adjustment of active seating systems 204 may be needed to offset the current movement.

In some aspects, data from AV inertia system 214 can be used to detect a current movement of AV 102 that was not anticipated. For example, AV 102 may experience unexpected movements due to low tire pressure, a flat tire, a mechanical malfunction, an unexpected road event (e.g., vehicle accident, emergency vehicle presence, etc.), and/or any other cause of an unanticipated movement. In some examples, local computing device 110 may use the data from AV inertia system 214 to detect the current movement of AV 102 and configure active seating systems 204 to offset the movement.

In some examples, local computing device 110 may identify anticipated movements of AV 102 based on historic data. In some cases, local computing device 110 can store movement data (e.g., data from AV inertia system 214) that is associated with parameters that can include location, route, speed, weather, etc. For example, local computing device 102 may identify anticipated movements of AV 102 based on the stored data corresponding to movements that occurred while previously travelling along the same route (e.g., poor road conditions cause vehicle vibrations on a portion of the route from downtown San Francisco to SFO airport). In some aspects, AV 102 may implement a machine learning algorithm that can be used to predict movement of AV 102 based on factors such as route, speed, weather, road conditions, location, traffic, etc.

In some aspects, the configuration of active seating systems 204 may be adjusted based on physical attributes associated with the passenger. For instance, local computing device 110 and/or seat control system 210 may modify the configuration of active seating systems 204 based on passenger weight, passenger height, and/or passenger shape. In some cases, passenger weight may be determined based on a weight sensor (e.g., seat sensor system 208). In some examples, a passenger may provide physical attributes to AV 102 using client computing device 170 (e.g., via ridesharing app 172). In some cases, seat control system 210 may be configured to use a default passenger configuration that includes default values for parameters such as height, weight, and size. In some aspects, the default parameters can be based on statistics for an average human.

In some examples, seat control system 210 may use seat inertia system 206 to calculate one or more metrics/parameters corresponding to the passenger. For example, seat inertia system 206 can be used to approximate a center of mass for the passenger. In another example, seat inertia system 206 can be used to measure movement of AV seats 202 in one or more directions in order to calculate a passenger comfort score.

In some cases, sensor system 104 can be used to determine and/or adjust metrics and/or parameters corresponding to the passenger. For example, AV camera system 216 can be used to view the passenger (e.g., outside and/or inside the AV 102) and approximate attributes such as passenger height, passenger weight, and/or passenger shape. In some cases, AV camera system 216 can be used to determine whether the passenger is male or female, or whether the passenger is an adult or a child. For example, a default passenger configuration can be used upon making a determination that the passenger is an adult female.

In some examples, active seating systems 204 may be automatically and/or optionally disabled. For example, a passenger may choose to disable active seating systems 204 using client computing device 170. In another example, local computing device 110 may disable active seating systems 204 upon determining that the corresponding AV seat (e.g., AV seat 202a or AV seat 202b) is vacant (e.g., based on data from seat sensor system 208). In another example, local computing device 110 may disable active seating systems 204 upon determining that a child car seat or a child booster seat has been positioned on one of AV seats 202. Alternatively, in some aspects, the configuration of active seating system 204 may be modified to operate with a child car seat and/or a child booster seat attached to AV seats 202.

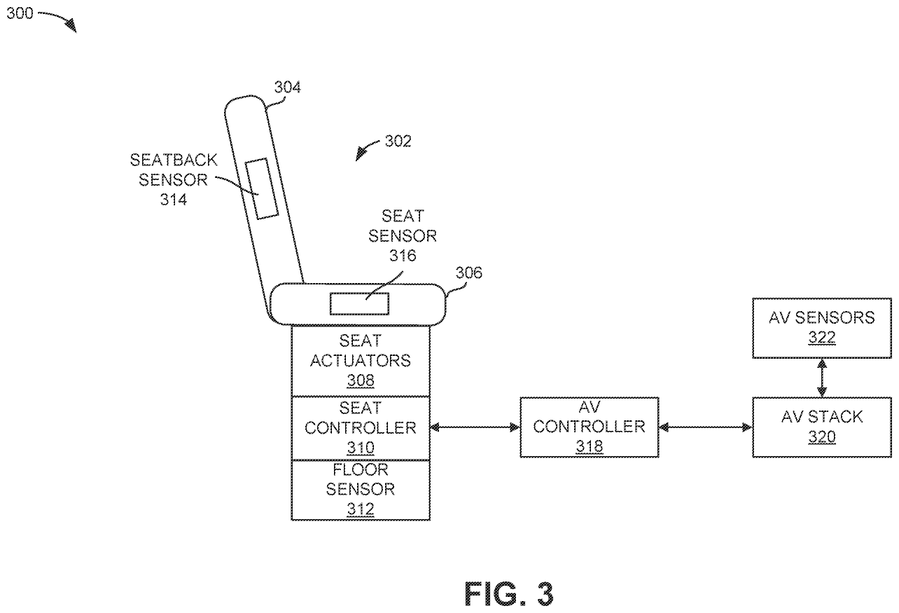

FIG. 3 illustrates an example system 300 for an active seating system for an autonomous vehicle. In some aspects, system 300 can include AV seat 302 having a seatback 304 and a seat bottom 306. In some cases, AV seat 302 can be coupled to an active seating system that can include seat actuators 308 and seat controller 310. In some aspects, seat controller 310 can interface and control seat actuators 308 to make AV seat 302 move in one or more directions (e.g., upward direction, downward direction, leftward direction, rightward direction, frontward direction, backward direction, pitch direction, roll direction, and/or yaw direction).

In some aspects, seat controller 310 can be communicatively coupled to AV controller 318 (e.g., local computing device 110). In some examples, AV controller 318 can send instructions to seat controller 310 to cause AV seat 302 to move in one or more directions. In some aspects, AV controller 318 can configure movement of AV seat 302 based on predicted or anticipated movements of the AV. In some examples, AV controller 318 can configure movement of AV seat 302 based on actual detected movement of the AV. In some instances, AV controller 318 can anticipate AV movement and/or detect AV movement based on data received from AV stack 320 and/or AV sensors 322. In some cases, AV stack 320 can include perception stack 112, localization stack 114, prediction stack 116, planning stack 118, communications stack 120, and/or control stack 122. In some examples, AV sensors can include sensor systems 104-108 (e.g., AV inertia system 214, AV camera system 216, AV LIDAR system 218, and/or AV radar system 220).

In some examples, AV seat 302 can include one or more sensors (e.g., seat sensor system 208). In some cases, AV seat 302 can include a floor sensor 312, a seatback sensor 314, and a seat sensor 316. In some aspects, floor sensor 312, seatback sensor 314, and seat sensor 316 can correspond to inertial measurement units (IMUs). In some cases, each of the floor sensor 312, seatback sensor 314, and seat sensor 316 can be configured to measure linear acceleration as well as angular rates. In some cases, the linear acceleration and/or the angular rates measured at the three different seat positions can be used to determine a passenger comfort score and/or to modify settings for position of AV seat 302 (e.g., using seat controller 310 to control seat actuators 308).

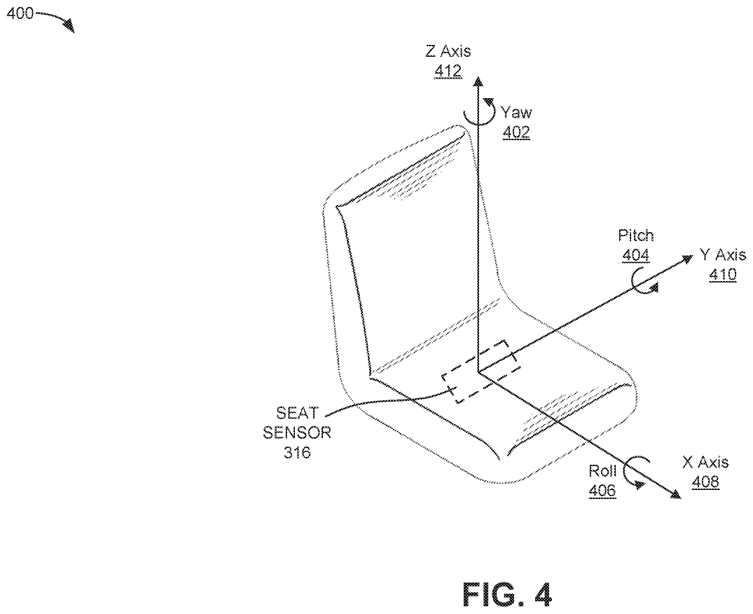

FIG. 4 illustrates an example of measurements that may be obtained from AV seat 400. As illustrated, AV seat 400 includes seat sensor 316 that is positioned at or near the seat cushion (the floor sensor 312 and seatback sensor 314 are not illustrated in FIG. 4 but may perform same or similar operations).

In some aspects, seat sensor 316 can be used to measure linear acceleration along X-axis 408, Y-axis 410, and/or Z-axis 412. In some cases, seat sensor 316 may be used to measure angular acceleration in the yaw 402 direction, the pitch 404 direction, and/or the roll 406 direction. In some examples, the measurements from seat sensor 316 (as well as floor sensor 312 and seatback sensor 314) can be used to customize settings for AV seat 400 (e.g., based on passenger characteristics). In some instances, the measurements from seat sensor 316 (as well as floor sensor 312 and seatback sensor 314) can be used to determine a passenger comfort score. For example, vibration measurements obtained from the seatback, the floor, and/or the seat can be used to calculate a frequency parameter (e.g., root mean squared value) for each direction. In some cases, the frequency parameter can be used to calculate a crest factor for each direction that can be used to determine the passenger comfort score.

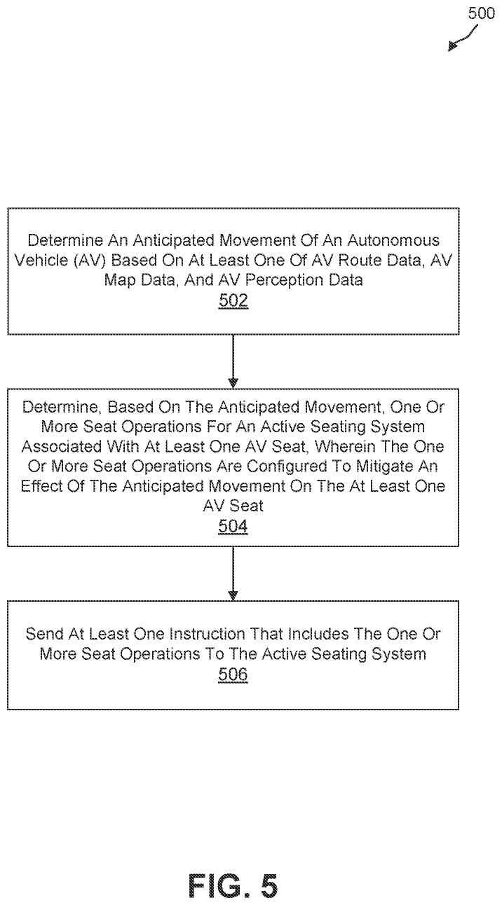

FIG. 5 illustrates an example of a process 500 for controlling an active seating system in an autonomous vehicle (AV). At block 502, the process 500 includes determining an anticipated movement of an autonomous vehicle (AV) based on at least one of AV route data, AV map data, and AV sensor data. For example, local computing device 110 can determine an anticipated movement of AV 102 based on data obtained from sensor system 104, perception stack 112, localization stack 114, prediction stack 116, planning stack 118, and/or control stack 122. In some aspects, the anticipated movement of the AV includes at least one of a stop, a turn, an acceleration, a deceleration, an inclination, a disinclination, and an uneven ride. In some cases, the AV route data includes AV suspension data corresponding to an AV route. For instance, local computing device 110 can obtain AV suspension data (e.g., IMU data) corresponding to a route that has been previously traveled in order to determine or identify anticipated movements.

At block 504, the process 500 includes determining, based on the anticipated movement, one or more seat operations for an active seating system associated with at least one AV seat, wherein the one or more seat operations are configured to mitigate an effect of the anticipated movement on the at least one AV seat. For example, local computing device 110 can determine, based on the anticipated movement, one or more seat operations for active seating system 204a associated with AV seat 202a. In some aspects, the one or more operations can be configured to mitigate or offset the effect of the anticipated movement on AV seat 202a.

In some examples, the one or more seat operations for the active seating system can be further based on a default passenger profile that includes one or more default physical attributes. For example, local computing device 110 can determine a default passenger profile that includes default values for passenger weight, passenger height, and/or passenger shape. In some cases, the default passenger profile can be used to adjust or determine the one or more seat operations for the active seating system.

At block 506, the process 500 includes sending at least one instruction that includes the one or more seat operations to the active seating system. For instance, local computing device 110 can send at least one instruction to seat control system 210 that includes the one or more seat operations to active seating systems 204. In some cases, the one or more seat operations cause at least one movement of the at least one AV seat, wherein the at least one movement includes at least one of a vertical movement, a lateral movement, a fore-and-aft movement, a pitch movement, a yaw movement, and a roll movement.

In some examples, the process 500 can include receiving the AV sensor data from an inertial measurement unit (IMU), wherein the AV sensor data corresponds to a time of the anticipated movement of the AV and adjusting the one or more seat operations for the active seating system based on the AV sensor data from the IMU. For instance, local computing device 110 can receive AV sensor data corresponding to AV inertia system 214 that corresponds to a time of the anticipated movement (e.g., current movement by AV 102). In some examples, local computing device 110 can adjust instructions to active seating systems 204 based on the IMU data.

In some aspects, the process 500 can include receiving the AV sensor data from one or more AV seat sensors. For example, seat sensor 316, floor sensor 312, and/or seatback sensor 314 can be used to determine seat vibrations and/or movements of an AV seat. In some cases, the vibrations and/or movements detected by the AV seat sensors can be cancelled or mitigated by the active seating system 204 (e.g., local computing device 110 can send instructions to active seating system 204 based on AV seat sensor data that cause the active seating system 204 to mitigate against seat vibrations detected by seat sensor 316, floor sensor 312, and/or seatback sensor 314).

In some cases, the process 500 can include determining one or more physical attributes corresponding to a passenger seated in the at least one AV seat, wherein the one or more physical attributes include at least one of passenger weight, passenger height, and passenger shape, and adjusting the one or more seat operations for the active seating system based on the one or more physical attributes. For example, local computing device 110 can determine physical attributes (e.g., weight, height, shape, etc.) of a passenger seated in AV seat 202a. In some aspects, local computing device 110 and/or seat control system 210 can adjust the one or more seat operations for active seating system 204a (e.g., corresponding to AV seat 202a) based on the physical attributes.

FIG. 6 illustrates an example processor-based system with which some aspects of the subject technology can be implemented. For example, processor-based system 600 can be any computing device making up internal computing system 110, a passenger device executing the ridesharing application 172, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some examples, computing system 600 is a distributed system in which the functions described in this disclosure can be distributed within a datacenter, multiple data centers, a peer network, etc. In some cases, one or more of the described system components represents many such components each performing some or all of the function for which the component is described. In some aspects, the components can be physical or virtual devices.

Example system 600 includes at least one processing unit (CPU or processor) 610 and connection 605 that couples various system components including system memory 615, such as read-only memory (ROM) 620 and random-access memory (RAM) 625 to processor 610. Computing system 600 can include a cache of high-speed memory 612 connected directly with, in close proximity to, and/or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 can include an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/9G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communications interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L9/L #), resistive random-access memory (RRAM/ReRAM), phase change memory (PCM), spin transfer torque RAM (STT-RAM), another memory chip or cartridge, and/or a combination thereof.

Storage device 630 can include software services, servers, services, etc., that when the code that defines such software is executed by the processor 610, causes the system to perform a function. In some examples, a hardware service that performs a particular function can include the software component stored in a computer-readable medium in connection with the necessary hardware components, such as processor 610, connection 605, output device 635, etc., to carry out the function.

As understood by those of skill in the art, machine-learning techniques can vary depending on the desired implementation. For example, machine-learning schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

Aspects within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special-purpose computer, or special-purpose processing device to perform a certain function or group of functions. By way of example, computer-executable instructions can be used to implement perception system functionality for determining when sensor cleaning operations are needed or should begin. Computer-executable instructions can also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other examples of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Aspects of the disclosure may also be practiced in distributed computing environments where tasks are performed by local and remote processing devices that are linked (either by hardwired links, wireless links, or by a combination thereof) through a communications network. In a distributed computing environment, program modules can be located in both local and remote memory storage devices.

### Selected Examples

Illustrative examples of the disclosure include:

Aspect 1. A method comprising: determining an anticipated movement of an autonomous vehicle (AV) based on at least one of AV route data, AV map data, and AV sensor data; determining, based on the anticipated movement, one or more seat operations for an active seating system associated with at least one AV seat, wherein the one or more seat operations are configured to mitigate an effect of the anticipated movement on the at least one AV seat; and sending at least one instruction that includes the one or more seat operations to the active seating system.

Aspect 2. The method of Aspect 1, wherein the anticipated movement of the AV includes at least one of a stop, a turn, an acceleration, a deceleration, an inclination, a disinclination, and an uneven ride.

Aspect 3. The method of any of Aspects 1 to 2, further comprising: receiving the AV sensor data from an inertial measurement unit (IMU), wherein the AV sensor data corresponds to a time of the anticipated movement of the AV; and adjusting the one or more seat operations for the active seating system based on the AV sensor data from the IMU.

Aspect 4. The method of any of Aspects 1 to 3, wherein the one or more seat operations for the active seating system are further based on a default passenger profile that includes one or more default physical attributes.

Aspect 5. The method of any of Aspects 1 to 4, further comprising: determining one or more physical attributes corresponding to a passenger seated in the at least one AV seat, wherein the one or more physical attributes include at least one of passenger weight, passenger height, and passenger shape; and adjusting the one or more seat operations for the active seating system based on the one or more physical attributes.

Aspect 6. The method of any of Aspects 1 to 5, wherein the AV route data includes AV suspension data corresponding to an AV route.

Aspect 7. The method of any of Aspects 1 to 6, wherein the one or more seat operations cause at least one movement of the at least one AV seat, wherein the at least one movement includes at least one of a vertical movement, a lateral movement, a fore-and-aft movement, a pitch movement, a yaw movement, and a roll movement.

Aspect 8. An apparatus comprising: at least one memory; and at least one processor coupled to the at least one memory, wherein the at least one processor is configured to perform operations in accordance with any one of Aspects 1 to 7.

Aspect 9. An apparatus comprising means for performing operations in accordance with any one of Aspects 1 to 7.

Aspect 10. A non-transitory computer-readable medium comprising instructions that, when executed by an apparatus, cause the apparatus to perform operations in accordance with any one of Aspects 1 to 7.

Aspect 11. An autonomous vehicle (AV) comprising: at least one active seating system; at least one memory comprising instructions; and at least one processor configured to execute the instructions and cause the at least one processor to: determine an anticipated movement of the AV based on at least one of AV route data, AV map data, and AV sensor data; determine, based on the anticipated movement, one or more seat operations for the at least one active seating system associated with at least one AV seat, wherein the one or more seat operations are configured to mitigate an effect of the anticipated movement on the at least one AV seat; and send at least one instruction that includes the one or more seat operations to the at least one active seating system.

Aspect 12. The AV of Aspect 11, wherein the anticipated movement of the AV includes at least one of a stop, a turn, an acceleration, a deceleration, an inclination, a disinclination, and an uneven ride.

Aspect 13. The AV of any of Aspects 11 to 12, further comprising an inertial measurement unit (IMU), wherein the at least one processor is further configured to: receive the AV sensor data from the IMU, wherein the AV sensor data corresponds to a time of the anticipated movement of the AV; and adjust the one or more seat operations for the at least one active seating system based on the AV sensor data from the IMU.

Aspect 14. The AV of any of Aspects 11 to 13, wherein the one or more seat operations for the at least one active seating system are further based on a default passenger profile that includes one or more default physical attributes.

Aspect 15. The AV of any of Aspects 11 to 14, wherein the at least one processor is further configured to: determine one or more physical attributes corresponding to a passenger seated in the at least one AV seat, wherein the one or more physical attributes include at least one of passenger weight, passenger height, and passenger shape; and adjust the one or more seat operations for the at least one active seating system based on the one or more physical attributes.

Aspect 16. The AV of any of Aspects 11 to 15, wherein the AV route data includes AV suspension data corresponding to an AV route.

Aspect 17. The AV of any of Aspects 11 to 16, wherein the one or more seat operations cause at least one movement of the at least one AV seat, wherein the at least one movement includes at least one of a vertical movement, a lateral movement, a fore-and-aft movement, a pitch movement, a yaw movement, and a roll movement.

The various examples described above are provided by way of illustration only and should not be construed to limit the scope of the disclosure. For example, the principles herein apply equally to optimization as well as general improvements. Various modifications and changes may be made to the principles described herein without following the examples and applications illustrated and described herein, and without departing from the scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A method comprising:
determining an anticipated movement of an autonomous vehicle (AV) based on at least one of AV route data, AV map data, and AV sensor data;
determining, based on the anticipated movement, one or more seat operations for an active seating system associated with at least one AV seat, wherein the one or more seat operations are configured to mitigate an effect of the anticipated movement on the at least one AV seat; and
sending at least one instruction that includes the one or more seat operations to the active seating system.

2. The method of claim 1, wherein the anticipated movement of the AV includes at least one of a stop, a turn, an acceleration, a deceleration, an inclination, a disinclination, and an uneven ride.

3. The method of claim 1, further comprising:
receiving the AV sensor data from an inertial measurement unit (IMU), wherein the AV sensor data corresponds to a time of the anticipated movement of the AV; and
adjusting the one or more seat operations for the active seating system based on the AV sensor data from the IMU.

4. The method of claim 1, wherein the one or more seat operations for the active seating system are further based on a default passenger profile that includes one or more default physical attributes.

5. The method of claim 1, further comprising:
determining one or more physical attributes corresponding to a passenger seated in the at least one AV seat, wherein the one or more physical attributes include at least one of passenger weight, passenger height, and passenger shape; and
adjusting the one or more seat operations for the active seating system based on the one or more physical attributes.

6. The method of claim 1, wherein the AV route data includes AV suspension data corresponding to an AV route.

7. The method of claim 1, wherein the one or more seat operations cause at least one movement of the at least one AV seat, wherein the at least one movement includes at least one of a vertical movement, a lateral movement, a fore-and-aft movement, a pitch movement, a yaw movement, and a roll movement.

8. An autonomous vehicle (AV) comprising:
at least one active seating system;
at least one memory comprising instructions; and
at least one processor configured to execute the instructions and cause the at least one processor to:
determine an anticipated movement of the AV based on at least one of AV route data, AV map data, and AV sensor data;
determine, based on the anticipated movement, one or more seat operations for the at least one active seating system associated with at least one AV seat, wherein the one or more seat operations are configured to mitigate an effect of the anticipated movement on the at least one AV seat; and
send at least one instruction that includes the one or more seat operations to the at least one active seating system.

9. The AV of claim 8, wherein the anticipated movement of the AV includes at least one of a stop, a turn, an acceleration, a deceleration, an inclination, a disinclination, and an uneven ride.

10. The AV of claim 8, further comprising an inertial measurement unit (IMU), wherein the at least one processor is further configured to:
receive the AV sensor data from the IMU, wherein the AV sensor data corresponds to a time of the anticipated movement of the AV; and
adjust the one or more seat operations for the at least one active seating system based on the AV sensor data from the IMU.

11. The AV of claim 8, wherein the one or more seat operations for the at least one active seating system are further based on a default passenger profile that includes one or more default physical attributes.

12. The AV of claim 8, wherein the at least one processor is further configured to:
determine one or more physical attributes corresponding to a passenger seated in the at least one AV seat, wherein the one or more physical attributes include at least one of passenger weight, passenger height, and passenger shape; and
adjust the one or more seat operations for the at least one active seating system based on the one or more physical attributes.

13. The AV of claim 8, wherein the AV route data includes AV suspension data corresponding to an AV route.

14. The AV of claim 8, wherein the one or more seat operations cause at least one movement of the at least one AV seat, wherein the at least one movement includes at least one of a vertical movement, a lateral movement, a fore-and-aft movement, a pitch movement, a yaw movement, and a roll movement.

15. A non-transitory computer-readable storage medium having stored thereon instructions which, when executed by one or more processors, cause the one or more processors to:
determine an anticipated movement of an autonomous vehicle (AV) based on at least one of AV route data, AV map data, and AV sensor data;
determine, based on the anticipated movement, one or more seat operations for an active seating system associated with at least one AV seat, wherein the one or more seat operations are configured to mitigate an effect of the anticipated movement on the at least one AV seat; and
send at least one instruction that includes the one or more seat operations to the active seating system.

16. The non-transitory computer-readable storage medium of claim 15, wherein the anticipated movement of the AV includes at least one of a stop, a turn, an acceleration, a deceleration, an inclination, a disinclination, and an uneven ride.

17. The non-transitory computer-readable storage medium of claim 15, comprising further instructions which, when executed by the one or more processors, cause the one or more processors to:
receive the AV sensor data from an inertial measurement unit (IMU), wherein the AV sensor data corresponds to a time of the anticipated movement of the AV; and
adjust the one or more seat operations for the active seating system based on the AV sensor data from the IMU.

18. The non-transitory computer-readable storage medium of claim 15, comprising further instructions which, when executed by the one or more processors, cause the one or more processors to:
determine one or more physical attributes corresponding to a passenger seated in the at least one AV seat, wherein the one or more physical attributes include at least one of passenger weight, passenger height, and passenger shape; and
adjust the one or more seat operations for the active seating system based on the one or more physical attributes.

19. The non-transitory computer-readable storage medium of claim 15, wherein the AV route data includes AV suspension data corresponding to an AV route.

20. The non-transitory computer-readable storage medium of claim 15, wherein the one or more seat operations cause at least one movement of the at least one AV seat, wherein the at least one movement includes at least one of a vertical movement, a lateral movement, a fore-and-aft movement, a pitch movement, a yaw movement, and a roll movement.
